(19) United States
(12) Patent Application Publication
(10) Pub. No.: US 2026/0208168 A1
(43) Pub. Date: Jul. 23, 2026

(54) HYDROPYROLYSIS CATALYST

(71) Applicant: SHELL USA, INC., Houston, TX (US)

(72) Inventors: Rikeshchandra Sharadchandra JOSHI, Bangalore North (IN); Patrick VANDER HOOGERSTRAETE, Wondelgem (BE); Pieter HUIZENGA, Amsterdam (NL)

(21) Appl. No.: 19/144,002

(22) PCT Filed: Jan. 11, 2024
(86) PCT No.: PCT/US2024/011164

§ 371 Date: Jun. 27, 2025

(30) Foreign Application Priority Data
Jan. 13, 2023 (IN) 202341002724

(51) Int. Cl. B01J 23/882; B01J 21/04; B01J 35/30; B01J 35/31; B01J 35/40; B01J 35/61; B01J 35/63; B01J 35/64; B01J 37/00; B01J 37/04; B01J 37/08; C10G 1/06

(52) U.S. Cl. CPC B01J 23/882; B01J 21/04; B01J 35/31; B01J 35/394; B01J 35/40; B01J 35/615; B01J 35/633; B01J 35/647; B01J 37/0018; B01J 37/04; B01J 37/08; C10G 1/06; C10G 2300/1011

(57) ABSTRACT

The present disclosure provides a hydropyrolysis catalyst that includes molybdenum and a metal selected from those in groups 8, 9 and 10 of the periodic table as active species and in the range of from 35 to 60 wt % of alpha alumina with a particle density of at least 3.5 g/cm³ and 30 to 60 wt % of an alumina, which is not alpha alumina, with a particle density of at least 0.8 g/cm³, based on the overall weight of the catalyst in oxidic form. The present disclosure also provides a method of producing the hydropyrolysis catalyst.

### FIELD OF THE INVENTION

This invention relates to a hydropyrolysis catalyst and a method for its preparation.

### BACKGROUND OF THE INVENTION

With increasing demand for liquid transportation fuels, decreasing reserves of ‘easy oil’ (crude petroleum oil that can be accessed and recovered easily) and increasing constraints on the carbon footprints of such fuels, it is becoming increasingly important to develop routes to produce liquid transportation fuels from alternative sources in an efficient manner.

Biomass offers a source of renewable carbon and refers to biological material derived from living or recently deceased organisms and includes lignocellulosic materials (e.g., wood), aquatic materials (e.g., algae, aquatic plants, and seaweed) and animal by-products and wastes (e.g., offal, fats, and sewage sludge). Liquid transportation fuels produced from biomass are sometimes referred to as biofuels. Therefore, when using such biofuels, it may be possible to achieve more sustainable CO₂ emissions over petroleum-derived fuels.

However, in the conventional pyrolysis of biomass, typically fast pyrolysis carried out in an inert atmosphere, a dense, acidic, reactive liquid bio-oil product is obtained, which contains water, oils and char formed during the process. The use of bio-oils produced via conventional pyrolysis is, therefore, subject to several drawbacks. These include increased chemical reactivity, water miscibility, high oxygen content and low heating value of the product. Often these products are difficult to upgrade to fungible liquid hydrocarbon fuels.

An efficient method for processing biomass into high quality liquid fuels is described in WO2010117437 and subsequent patents describing the IH² process developed by Shell and Gas Technology Institute, such as U.S. Pat. Nos. 10,005,965, 9,868,909, 10,005,964, US20170009143, U.S. Pat. Nos. 10,167,429, 10,526,544, 11,174,438, 10,822,545, 10,174,259, 10,190,056, 10,774,270, 10,829,695, 10,647,924, 10,822,546, 9,657,232, 10,183,279 and WO2022133224. The processes for the conversion of biomass into liquid hydrocarbon fuels described in WO2010117437 use a first hydropyrolysis reaction and a subsequent hydroconversion reaction to convert biomass into useable products.

Solid feedstocks such as feedstocks containing waste plastics and feedstocks containing lignocellulose (e.g. woody biomass, agricultural residues, forestry residues, residues from the wood products and pulp & paper industries and municipal solid waste containing lignocellulosic material) are important feedstocks for biomass to fuel processes due to their availability on a large scale. Lignocellulose comprises a mixture of lignin, cellulose and hemicelluloses in any proportion and usually also contains ash and moisture.

The hydropyrolysis stage of the process described in WO2010117437 utilises a hydropyrolysis catalyst. Typical hydropyrolysis catalysts used in this process comprise a mixture of cobalt or nickel in combination with molybdenum and phosphorus on a gamma alumina carrier. The hydropyrolysis reaction takes place in a bubbling fluidised bed reactor in which biomass is fed to the bottom of the reactor. The biomass is rapidly heated in contact with hot hydropyrolysis catalyst under a hydrogen atmosphere. The catalyst must have certain properties with respect to size and density in order to achieve a fluidised bed with the necessary flow and reaction. Some catalyst will pass out of the top of the bed and must be separated from the hydropyrolysis product and char. Optimising the density of the catalyst particles would facilitate separation from the char and allow catalyst to quickly pass through downcomers and to be rapidly returned to the main reactor body with minimal heat loss.

As well as being of the correct size and density, the hydropyrolysis catalyst must retain the metal loading ability and surface area required to provide the necessary catalytic activity.

### SUMMARY OF THE INVENTION

The present invention provides a hydropyrolysis catalyst, said catalyst comprising molybdenum and a metal selected from those in groups 8, 9 and 10 of the periodic table as active species and in the range of from 35 to 60 wt % of alpha alumina with a particle density of at least 3.5 g/cm³ and 30 to 60 wt % of an alumina, which is not alpha alumina, with a particle density of at least 0.8 g/cm³, based on the overall weight of the catalyst in oxidic form.

The present invention also provides a method of producing a hydropyrolysis catalyst, said process comprising the steps of:
coprocessing a mixture of an alpha alumina with a particle density of at least 3.5 g/cm³ with an alumina precursor, a source of a metal selected from those in 8, 9 and 10 of the periodic table, a molybdenum source, water and an acid selected from acetic acid and nitric acid; and
extruding and drying the mixture and then calcining it at a temperature in the range of from at least 450° C. and at most 900° C. to provide a finished catalyst.

### DETAILED DESCRIPTION OF THE INVENTION

One or more specific embodiments of the present disclosure will be described below. These described embodiments are examples of the presently disclosed techniques. Additionally, in an effort to provide a concise description of these embodiments, not all features of an actual implementation may be described in the specification. It should be appreciated that in the development of any such actual implementation, as in any engineering or design project, numerous implementation-specific decisions will be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present inventors have found that a hydropyrolysis catalyst with optimised density can be obtained through the use of alpha alumina in the range of from 35 to 60 wt % based on the overall weight of the finished catalyst in combination with a non-alpha alumina. A simplified process for making such a catalyst, in which the alumina/alumina precursors are co-mulled with the metal sources before extrusion, drying and calcining within a specific temperature range, has also been developed.

The hydropyrolysis catalyst of the present invention comprises both alpha and a non-alpha alumina. These materials act as a carrier to and provide a surface for active species in the hydropyrolysis catalyst.

The alpha alumina is present in the range of from 35 to 60 wt % based on the overall weight of the hydropyrolysis catalyst. Preferably, alpha alumina is present in the range of from 45 to 50 wt % based on the overall weight of the hydropyrolysis catalyst.

The alpha alumina has a particle density of at least 3.5 g/cm³, preferably at least 4.0 g/cm³. Also preferably, the particle density of the alpha alumina is no more than 4.5 g/cm³.

The alumina, which is not alpha alumina (termed herein non-alpha alumina), in the hydropyrolysis catalyst is present in the range of from 30 to 50 wt % based on the overall weight of the hydropyrolysis catalyst. Preferably, said non-alpha alumina is present in the range of from 35 to 40 wt % based on the overall weight of the hydropyrolysis catalyst.

The non-alpha alumina has a particle density of at least 0.8 g/cm³, preferably at least 1.0 g/cm³. Also preferably, the particle density of the non-alpha alumina is no more than 1.2 g/cm³.

The particle density of the non-alpha alumina produced from any precursor can readily be measured by calcining a portion of the precursor and measuring the particle density of the alumina thus produced.

The non-alpha alumina may be any alumina which is not alpha alumina. Gamma (γ), chi (χ) and eta (η) aluminas are preferred. Gamma alumina is particularly preferred.

The hydropyrolysis catalyst also comprises molybdenum and a metal selected from those in groups 8, 9 and 10 of the periodic table as active species. For clarity, groups 8, 9 and 10 of the periodic table are those according to “Nomenclature of Inorganic Chemistry”-IUPAC Recommendations 2005. Preferred metals in groups 8, 9 and 10 of the periodic table are selected from one or more of cobalt, iron, nickel, copper and manganese. Even more preferably, the metal or metals in groups 8, 9 and 10 of the periodic table are one or more of cobalt and nickel.

The metal content of the metal or metals selected from those in groups 8, 9 and 10 of the periodic table in the hydropyrolysis catalyst is typically in an amount in the range of from 0.5 wt % to 20 wt %, preferably from 1 wt % to 15 wt %, and, most preferably, from 2 wt % to 12 wt % based on the overall weight of the catalyst.

The metal content of the molybdenum in the hydropyrolysis catalyst is typically in an amount in the range of from 5 wt % to 50 wt %, preferably from 8 wt % to 40 wt %, and, most preferably, from 12 wt % to 30 wt % based on the overall weight of the catalyst.

These active species are typically present as metal oxides, metal sulfides, or reduced metallic form in the active catalyst.

Phosphorus may also be incorporated in the hydropyrolysis catalyst as an active species. If present, the content of the phosphorus in the hydropyrolysis catalyst is typically in an amount in the range of from 0.1 wt % to 5 wt %, preferably from 2 wt % to 4 wt %, and, most preferably, from 2 wt % to 3 wt % based on the overall weight of the catalyst.

Further, tungsten may also be incorporated in the hydropyrolysis catalyst as an active metal species. If present, the content of the tungsten in the hydropyrolysis catalyst is typically in an amount in the range of from 1 wt % to 20 wt %, preferably from 5 wt % to 10 wt %, based on the overall weight of the catalyst.

The present invention also provides a method of producing said hydropyrolysis catalyst, said process comprising the steps of co-mulling a mixture of an alpha alumina with a particle density of at least 3.5 g/cm³ with an alumina precursor, a source of a metal selected from those in groups 8, 9 and 10 of the periodic table, a molybdenum source, water and an acid selected from acetic acid and nitric acid; extruding and drying the mixture and then calcining it at a temperature in the range of from at least 450° C. and at most 900° C. to provide a finished catalyst.

The alumina precursor is selected from any material that will form a suitable non-alpha, preferably gamma, eta or chi, alumina of a suitable particle density during the method of the present invention when calcined at a temperature in the range of from at least 450° C. and at most 900° C. This includes, but is not limited to boehmite, pseudoboehmite, gibbsite, bayerite. A preferred non-alpha alumina is gamma alumina and the preferred alumina precursor is pseudoboehmite.

The alumina precursor is preferably added in an amount that will result in the range of from 35 to 60 wt % of non-alpha alumina based on the overall weight of the hydropyrolysis catalyst in the finished hydropyrolysis catalyst.

The alpha alumina and alumina precursor are combined with a source of a metal selected from those in groups 8, 9 and 10 of the periodic table and a molybdenum source and a phosphorus source.

Suitable metal sources include, but are not limited to cobalt hydroxide, cobalt oxide, cobalt (II) nitrate hexahydrate, cobalt hydroxycarbonate, Cobalt oxide, nickel hydroxide, nickel hydroxycarbonate, nickel nitrate and nickel oxide.

Suitable molybdenum sources include, but are not limited to, ammonium heptamolybdate, molybdenum trioxide, ammonium dimolybdate and molybdenum dioxide

If a phosphorus source is also included suitable phosphorous sources include but are not limited to phosphoric acid and phosphorous pentoxide.

Water and an acid selected from acetic acid and nitric acid, preferably nitric acid, are also included in the mixture for coprocessing. The amount of the liquid used is suitably chosen such that the Loss On Ignition (LOI) at 700° C. of the mixture is from equal to or more than 20 wt % to equal to or less than 70 wt % based on the total weight of the catalyst composition, preferably from equal to or more than 25 wt & to equal to or less than 65 wt % and more preferably from equal to or more than 30 wt % to equal to or less than 60 wt %. It is noted that the other ingredients of the catalyst may also contain water in various forms (e.g. physically adsorbed water, crystal water, water bound in hydroxide). Instead of specifying the total amount of water that is present in a catalyst composition, it is therefore common and unambiguous to quantify the Loss on Ignition at a certain temperature (i.e. 700° C.). LOI is in fact the total content of water in the above forms, plus e.g. CO₂ released from carbonates, plus volatiles and combustibles.

In a preferred embodiment, other additives may be incorporated into the mixture for coprocessing as flow improving agents and/or extrusion aids. Suitable additives for inclusion in the mixture include fatty amines, quaternary ammonium compounds, polyvinyl pyridine, sulphonium, sulphonium, phosphonium and iodonium compounds, alkylated aromatic compounds, acyclic carboxylic acids (such as citric acid), fatty acids, sulphonated aromatic compounds, alcohol sulphates, ether alcohol sulphates, sulphated fats and oils, phosphonic acid salts, polyoxyethylene alkylphenols, polyoxyethylene alcohols, polyoxyethylene alkylamines, polyoxyethylene alkylamides, polyacrylamides, cellulose derivatives (such as hydroxymethylcellulose), polyols (such as polyvinylalcohol) and acetylenic glycols. The extrusion aids are preferably chosen from the group consisting of citric acid, polyvinylalcohol, hydroxymethylcellulose and/or mixtures thereof. In a preferred embodiment, each of the extrusion aids citric acid, polyvinylalcohol and hydroxymethylcellulose are used.

Suitably the flow improving agents and/or the extrusion aids are mixed in the metal/alumina mixture in weight percentages between 0.5% and 5% relative to the mass of the mixture. Preferably the total weight percentage of extrusion aids relative to the mixture is from 0.5% to 15%, more preferably from 18 to 10%, even more preferably equal to or less than 78, and most preferably equal to or less than 5%.

The coprocessing may be carried out in any suitable way to provide a mixture suitable for extruding.

During the coprocessing step pressures applied are preferably equal to or less than 0.5 MegaPascal (corresponding to equal to or less than about 5 bar). More preferably the mixing is carried out at ambient pressure (corresponding to a pressure of about 0.1 MegaPascal, i.e. about 1 bar).

Typically, in the co-processing step, the ingredients of the mixture are processed for a period of from 5 to 120 minutes, preferably from 15 to 90 minutes, Any suitable, commercially available processing machine may be employed. Suitable methods of coprocessing include, but are not limited to mulling, mixing in a sigma blender, mixing in z-blade mixed or using a mixtruder, where mixing and extrusion occur in a single unit. During the mulling process, energy is put into the mixture by the mixing apparatus. As a result of the energy input into the mixture during the mixing process, there will be a rise in temperature of the mixture during coprocessing. The coprocessing process may be carried out over a broad range of temperatures, preferably in the range from equal to or more than 15° C. to equal to or less than 100° C., more preferably equal to or less than 80° C. Most preferably the coprocessing is carried out at room temperature (about 20° C.).

It will be appreciated that the mixture obtained in the coprocessing step may not be of the desired size and shape. The mixture is, therefore, shaped by extrusion. Extrusion may be effected using any conventional, commercially available extruder. In particular, a screw-type extruding machine may be used to force the mixture through the orifices in a suitable die plate to yield extrudates of the desired form. The strands formed upon extrusion may be cut to the desired length to form a shaped catalyst precursor.

The shaped catalyst precursor will be sized suitably to create catalyst particles of a desirable size. Average catalyst particles sizes, for use in a commercial fluidised bed reactor for hydropyrolysis, are preferably in the range of from 0.30 mm to 0.60 mm, more preferably in the range of from 0.40 mm to 0.60 mm, and most preferably in the range of from 0.45 mm to 0.55 mm.

The catalyst precursor is then dried. The drying temperature under which the step of drying the catalyst precursor is conducted should not exceed a calcination temperature. Thus, the drying temperature should not exceed 400° C., and, preferably, the drying temperature at which the catalyst precursor is dried does not exceed 300° C., and, most preferably, the drying temperature does not exceed 250° C. It is understood that this drying step will, in general, be conducted at lower temperatures than the aforementioned temperatures, and, typically, the drying temperature will be conducted at a temperature in the range of from 60° C. to 150° C.

The catalyst precursor is then calcined in the presence of air or oxygen at a temperature in the range of from at least 450° C. and at most 900° C. Within this temperature range, calcination will lead to the formation of one or more aluminas other than alpha alumina. The formation of alpha alumina requires calcination at a higher temperature, e.g. 1050° C. or higher. Preferably the calcination is carried out at a temperature no higher than 700° C., more preferably no higher than 600° C.

A typical hydropyrolysis process in which the catalyst of the invention and/or produced according to the process of the invention may be used is now described. This process is non-limiting and is used here in merely to illustrate the effect of the present invention.

A hydropyrolysis process generally comprises supplying a biomass feedstock and fluidising gas comprising hydrogen to a fluidised bed reactor comprising a deoxygenating or “hydropyrolysis” catalyst that is operating at an elevated temperature and pressure. The term “hydropyrolysis” is used generally to refer to a process by which a biomass feedstock is rapidly heated and thermally decomposed, in the presence of solid catalyst particles in an atmosphere consisting largely of hydrogen gas. The hydropyrolysis process provides a means to remove oxygen from biomass and other feedstocks containing significant quantities of carbon and chemically bonded oxygen to produce light hydrocarbons products with a large portion of the oxygen removed from the feedstock-derived liquid. A representative hydropyrolysis process has been described in detail in, among others, U.S. Pat. Nos. 8,492,600 and 8,841,495.

A fluidised bed reactor of a typical hydropyrolysis process generally comprises a mixing zone, a bulk reactor zone and optionally, an expanded solids disengagement zone (i.e., a section of expanded reactor diameter or cross-sectional area, relative to the diameter or cross-sectional area of the fluidised bed) at a suitable height above the bulk reactor zone in order to promote the separation of solid char particles from solid catalyst particles. The fluidised bed reactor further comprises one or more downcomers fluidly connecting the bulk reactor zone located at or near the top of the reactor to the mixing zone located at or near the bottom part of the reactor.

Fluidisation in the mixing zone and bulk reactor zone of the fluidised bed reactor may be performed with a fluidising gas having a superficial velocity effective for carrying out the type of fluidisation desired (e.g., bubbling bed fluidisation), considering the properties of the biomass feedstock, conditions within the reactor, and the particular fluidising gas being used. In general, a fluidising gas comprising hydrogen will have a superficial velocity of generally greater than about 0.1 meters per second (m/s) (e.g., from about 0.1 m/s to about 20 m/s), greater than 0.2 m/s (e.g. from about 0.2 m/s to about 1.5 m/s), typically greater than about 0.3 m/s (e.g., from about 0.3 m/s to about 1.2 m/s), and often greater than about 0.5 m/s (e.g., from about 0.5 m/s to about 1 m/s). Suitable fluidising gas streams comprise primarily hydrogen, but may also contain other non-condensable gases (e.g. CO, CO₂, and/or CH₄).

Preferably, the superficial gas velocity of the fluidising gas in the mixing zone is the same as or higher than that in the bulk reactor zone. Generally speaking, a higher superficial gas velocity in the mixing zone enables the use of larger biomass particles as compared to a standard fluidised bed as they do not sink to the bottom and form deposits. It is within the ability of one skilled in the art to select a suitable combination of superficial gas velocity, length of mixing zone and diameter of mixing zone, taking into consideration, for example, the rate at which the biomass feedstock is fed into the mixing zone, the amount of catalyst circulated and partial pressure of hydrogen within the reactor, the desired residence time of the biomass, catalyst, and fluidising gas, etc. It also within the ability of one skilled in the art to determine a suitable combination of superficial gas velocity, length of mixing zone and diameter of mixing zone such that backmixing of biomass from a bulk reactor zone located above the mixing zone is negligible, taking into consideration, for example, the dimensions of the mixing zone and the bulk reactor zone.

Conditions in the fluidised bed reactor include a temperature generally in the range of from 330° C. to 500° C., preferably from 350° C. to 480° C., more preferably from 370° C. to 450° C. The exact operating temperature depends upon the composition of the feedstock that is to undergo hydropyrolysis, the characteristics of the hydropyrolysis catalyst, and the desired composition of products that is to be obtained. The pressure within the reactor is typically in the range of from 0.50 MPa to 7.50 MPa. The exact operating pressure of the fluidised bed reactor depends upon the composition of the feedstock that is to undergo hydropyrolysis, the choice of catalyst, the composition of the fluidising gas (i.e. the hydrogen rich gas purity) and the desired composition of products that are to be obtained. The weight hourly space velocity (WHSV) in the reactor, calculated as the combined weight flow rate of the biomass feedstock, divided by the weight of the catalyst inventory in the reactor, is generally from about 0.1 hr⁻¹ to about 10 hr⁻¹, typically from about 0.5 hr⁻¹ to about 5 hr⁻¹, and often from about 0.8 hr⁻¹ to about 3 hr⁻¹. In general, the fluidisation velocity, catalyst size and bulk density and feedstock size and bulk density are chosen such that the deoxygenation catalyst remains in the fluidised bed, while the char produced gets entrained out of the reactor.

Such a hydropyrolysis processes produces a hydropyrolysis reactor output comprising a partially deoxygenated hydropyrolysis product (e.g., in the form of a condensable vapour), at least one non-condensable gas (e.g., CO, CO₂, and/or CH₄), and char particles. As used herein, the “partially deoxygenated hydropyrolysis product” may comprise oxygenated hydrocarbons (e.g., derived from cellulose, hemicellulose, and/or lignin) that may be subjected to more complete deoxygenation (e.g., to produce hydrocarbons and remove the oxygen in the form of CO, CO₂, and/or water) in a subsequent (downstream) hydroconversion process. Representative oxygen contents of the partially deoxygenated hydropyrolysis product are generally in the range from about 1 to about 30% by weight, or from about 5 to about 25% by weight.

Following hydropyrolysis all, or substantially all, of the char particles and/or other solid particles (e.g., catalyst fines) are removed from the hydropyrolysis reactor output to provide a purified hydropyrolysis reactor vapour stream having a reduced char content. The method of char and catalyst fines removal is generally not limited, and may include any method suitable for use with such hydropyrolysis processes. A preferred method of char and catalyst fines removal from the vapour stream is by cyclone separation. Catalyst particles may also be present in the hydropyrolysis reactor output and these will be separated. The catalyst produced by the process of the present invention advantageously has a suitable density to allow simple separation of the catalyst particles and their return to the fluidized bed without considerably heat loss.

The invention will now be further illustrated by reference to the following non-limiting examples.

### EXAMPLES

### Example 1

A mixture was prepared from commercial Alpha alumina powder sourced from Almatis (Almatis CT 3000 SG), commercial pseudoboehmite powder sourced from PIDC (PB 950), cobalt (II) nitrate hexahydrate, molybdenum trioxide powders in a ratio leading to an overall composition of 32.75 wt % gamma alumina, 49.12 wt % alpha alumina, 3.13 wt % CoO, 15% MoO₃ on a dry oxide mass weight basis. To the mixture were further added, Nitric acid (1.5 wt %), polyvinyl alcohol (Mowiol grade 18-88 from Kuraray, 1 wt %) and hydroxy methylcellulose (Methocel K15M, 1 wt %) extrusion aids (the quantities are relative to the mass of dry oxide), and demineralized water such that the total content of water plus combustibles of the mixture amounts to 34 wt % of total mass, as defined by the loss on ignition (LOI) at 485° C.

The mixture was kneaded and shaped by extrusion, and the resulting extrudates were dried at 140° C. for 2 hours and subsequently calcined at 500° C. for 2 hours. Physical properties of the catalyst are summarized in Table 1.

TABLE 1

| | |
|---|---|
| Co, wt % | 2.3 |
| Mo, wt % | 10 |
| Compacted Bulk density, g/cc | 1.2 |
| Particle density, g/cc | 2 |
| BET Surface area, m²/g | 135 |
| N₂ BET Pore volume, cc/g | 0.18 |
| N₂ BET Pore Diameter, nm | 7.5 |

The catalyst prepared in Example 1 was used as a hydropyrolysis catalyst in a bubbling fluidised bed reactor. The catalyst was ground and sieved to a particle size range of 300 micron to 500 micron. A second, hydrotreating catalyst (containing X and Y on Z) was dried to remove moisture before weighing. The dried hydrotreating catalyst, in the form of extrudates of 1.3 mm diameter and approximately 3 mm to 6 mm length, was used as the catalyst in a second, fixed bed, reactor. Neither the hydropyrolysis catalyst nor the hydrotreating catalyst underwent any activation treatment (such as sulfidation) prior to loading in the reactor. The solid feedstock used was sawdust generated in a paper and pulp mill as a co-product. The sawdust was sieved to a particle size of 250 micron to 500 micron.

The hydropyrolysis catalyst in the first reactor was fluidised with a stream of hydrogen preheated to a temperature of approximately 435° C. After the hydropyrolysis catalyst had been fluidised, the biomass was introduced into the reactor and processed in a continuous manner. The rate of processing of biomass was gradually ramped up to the target rate of 4.14 g/min, corresponding to a weight hourly space velocity of the biomass feedstock to the first stage reactor of approximately 1.26 kg biomass per kg catalyst per hour. The weighted average temperature of the fluidised bed of catalyst was 414.0° C. over the duration of biomass processing. The biomass feedstock was converted to a mixture of char, ash and vapours in the first reactor. The fluidisation velocity was adjusted in such a way that the solid products (char, ash) and the vapour phase products were carried out of the reactor, while the catalyst remained in the reactor. Some catalyst was attrited into fines, and the fines were carried out of the bed as well. The solid product was separated from the vapour phase product in a filter and the vapours were sent to the second reactor. The average temperature of the second stage hydrotreating catalyst was maintained at 388.0° C. The biomass feeding rate was gradually ramped up to the final WHSV to the second stage of 0.36 kg biomass per kg catalyst per hour. Operating pressure for both first and second stage was 2260 KPa barg. The vapour phase product of second stage reactor was cooled in stages to −46° C. and a two-layer liquid product containing a hydrocarbon layer floating on an aqueous layer was recovered. The hydrocarbon liquid was separated from the aqueous liquid and was analysed. The off gas from the process was sent to an online GC, and composition of the gas was analysed throughout the run. The mass balance and carbon balance of the process was calculated from the mass and analysis of the liquid products and compositional information of the gas product, based on which the yield profile was calculated. It was found that the hydrocarbon liquid product contained essentially no oxygen (below the detection limit of the instrument or <0.01 wt %), and the aqueous product produced contained only 0.01 wt % carbon. Thus, complete hydrodeoxygenation of the biomass was achieved producing an oxygen-free hydrocarbon product, and substantially carbon-free aqueous phase. Results are summarized in Table 2.

Table 2 also contains “standard range” results which are expected levels obtained when a typical hydrotreating catalyst containing cobalt and molybdenum on alumina (CAT A) is used as the first stage ‘hydropyrolysis’ catalyst.

TABLE 2

| | | Catalyst from |
|---|---|---|
| Parameter | Standard Range | Example 1 |
| Feedstock | Pinus Sylvestris | Pine Saw Dust |
| First Stage Catalyst | CAT A | Catalyst from |
| | | Example 1 |
| Second Stage | CAT B | CAT B |
| Catalyst | | |
| Hydrogen addition | 4-6 | 5.22 |
| (% wof MAF) | | |
| 1st Stage WABT (° C.) | 400-430 | 415 |
| 2nd Stage WABT (” C.) | 340-370 | 360 |
| Pressure (barg) | ~22.4 | 22.4 |
| C4+ Hydrocarbon | 24-28 | 28.1 |
| yield (% wof MAF) | | |
| C1-C3 Hydrocarbon | 10-20 | 14.0 |
| yield (% wof MAF) | | |

These results demonstrate that the catalyst made in Example 1 provides results in the conversion of biomass, via hydrodeoxygenation, hydropyrolysis and hydroconversion processes, that are within desirable ranges when compared to a standard process. However, the catalyst made in Example 1 has a higher particle density (2 g/cm³) compared to a standard catalyst (CAT A—1 g/cm³) used in a typical process. This allows an improved downcomer flux in a fluidised bed reactor and excellent fluidisation behaviour within the bed, providing efficient heat management across the reactor system.

1. A hydropyrolysis catalyst, said catalyst comprising molybdenum and one or more metal selected from those in groups 8, 9 and 10 of the periodic table as active species and in the range of from 35 to 60 wt % of alpha alumina with a particle density of at least 3.5 g/cm³ and 30 to 60 wt % of an alumina, which is not alpha alumina, with a particle density of at least 0.8 g/cm³, based on the overall weight of the catalyst in oxidic form.

2. A catalyst as claimed in claim 1, wherein the one or more metal selected from those in groups 8, 9 and 10 of the periodic table are selected from cobalt and/or nickel.

3. A catalyst as claimed in claim 1, wherein the alumina, which is not alpha alumina, has a particle density of at least 0.8 g/cm³ and no more than 1.2 g/cm³.

4. A catalyst as claimed in claim 1, wherein the average catalyst particle size is in the range of from 0.30 mm to 0.60 mm, more preferably in the range of from 0.40 mm to 0.60 mm, and most preferably in the range of from 0.45 mm to 0.55 mm.

5. A method of producing a hydropyrolysis catalyst, said process comprising the steps of:
coprocessing a mixture of an alpha alumina with a particle density of at least 3.5 g/cm³ with an alumina precursor, a source of a metal selected from those in 8, 9 and 10 of the periodic table, a molybdenum source, water and an acid selected from acetic acid and nitric acid; and
extruding and drying the mixture and then calcining it at a temperature in the range of from at least 450° C. and at most 900° C. to provide a finished catalyst.

6. A method as claimed in claim 5, wherein the alumina precursor is selected from one or more of boehmite, pseudoboehmite, gibbsite and bayerite.

7. A method as claimed in claim 5, wherein the mixture also comprises extrusion aids selected from one or more of citric acid, polyvinylalcohol and hydroxymethylcellulose.

8. A process for the hydropyrolysis of biomass, said process comprising the steps of contacting biomass with a hydropyrolysis catalyst in a bubbling fluidised bed reactor under a hydrogen atmosphere, wherein the hydropyrolysis catalyst is according to claim 1.
